(19) United States
(12) Patent Application Publication
(10) Pub. No.: US 2014/0099805 A1
(43) Pub. Date: Apr. 10, 2014

(54) ELECTRONIC CONNECTOR CAPABLE OF ACCEPTING A SINGLE SUBSCRIBER IDENTITY MOPDULE OR A MEMORY CARD

(71) Applicant: MOTOROLA MOBILITY LLC, Libertyville, IL (US)

(72) Inventors: Eric J. Kutchery, Salem, WI (US); Paul L. Fordham, Wauconda, IL (US)

(73) Assignee: MOTOROLA MOBILITY LLC, Libertyville, IL (US)

(21) Appl. No.: 13/648,407

(22) Filed: Oct. 10, 2012

(51) Int. Cl. H01R 12/55

(52) U.S. Cl. 439/76.1

(57) ABSTRACT

An electronic communications device 102 can be provided with one or more different electronic connectors 104 and 106 for accepting varying data cards 108 or 110. A slot 138 or 140 in the electronic communications device can receive the data cards. The connector 106 can comprise of a push-push connector 168, a push-pull connector 170 or an elongated card access tray 182. The versatile single connector can have a first data card-receiving cavity 142 for receiving a data card 108, such as a nano-SIM 4^{th} form-factor (4FF) card, and a second data card-receiving cavity 144 for receiving a data card 110, such as a microSD (uSD) card. The versatile single connector can have portions of the cavities 142 and 144 overlapping each other to provide a common minimal connector footprint 150 comprising of a single shared data card opening 138 or 140 for receiving, accepting, connecting and detecting only one of the data cards at a time in the device. Elements in the connector, device, or tray geometry can be of a size and shape to bias the data card and to prevent more than one data card from being inserted at a time into the single connector.

### BACKGROUND OF THE INVENTION

1. Field of the Disclosure

The disclosure relates in general to electronic communication devices and more particularly to mobile electronic devices, such as a mobile telephone with a connector for accepting a SIM card or a SD card.

2. Background Art

Mobile electronic devices, such as cellular phones, tablets, etc., are now required to accept multiple types of end-user external inserted cards. An example of an inserted card is a Subscriber Identity Module card (SIM card) which is an integrated circuit that securely stores the International Mobile Subscriber Identity and related keys used to identify and authenticate subscribers, store a limited amount of data such as a maximum of 250 contact names and phone numbers, as well as subscribers identity, security, and personal information to identify users on a cell phone network, and can be transferred between different mobile devices. SIM cards have become more miniaturized over the years. They come in the full-size SIM 1^{st} form factor (1FF), mini-SIM 2^{nd} form-factor (2FF), micro-SIM 3^{rd} form-factor (3FF), and nano-SIM 4^{th} form-factor (4FF). The 4FF SIM can be put into adapters for use as a 2FF or 3FF SIM, so they are backward compatible. On some networks, the mobile phone is locked to its carrier SIM card, meaning that the phone only works with SIM cards from the specific carrier.

Secure Device cards (SD cards), also known as Super Density cards, are another example of inserted cards used in mobile devices. SD cards are non-volatile memory cards used to store data for use in a range of portable devices. SD cards retain data without drawing power from the battery of a mobile device. SD cards are available in three different form factors. The standard SD, the miniSD, and the microSD (originally named the TransFlash or TF). The microSD (uSD) is the smallest memory card that can presently be purchased. It is about a quarter of the size of a standard SD card. There are adapters which make the uSD able to fit in the products which have slots for standard SD and miniSD. The uSD format was created by the company SanDisk. The amount of power used by uSD cards is different for each card because they are made by different manufacturers, but the card typically has a range of 20-100 mA at a supply voltage of 2.2 V.

The United States and Europe are SIM and uSD supported. Asia is dual SIM supported. However, each company producing SIM cards and each country uses its own version of SIM card. Tablet devices use SIM cards if they have a cell version, or uSD cards if they have a WiFi only version. Music players use uSD cards.

The present invention relates to a card connector, especially to a card connector which is adapted for insertion of cards of different types, such as SIM and uSD. Within a mobile device, different connectors are needed to load different cards. However, one card connector only loads one corresponding card, so the mobile device needs to be designed with different card connectors. Using multiple different connectors is costly from a supply chain standpoint because multiple different connectors must be stocked. Therefore, a card connector which can load different cards is desirable.

At present, a card connector which can load different cards has a plurality of inserting cavities for receiving different cards. In such situations, there is a problem of how to avoid accepting different cards at the same time. Because the card connector is needed to design special softwares and add inspecting contacts to expand its functions, there are numerous difficulties in design and manufacture.

A stacked card connector including a first card connector such as a SIM card connector and a second card connector such as an SD card connector has been used. A conventional SD card connector usually comprises a push-push ejector for guiding/ejecting an SD card. Typically a user inserts a SIM card in the SIM card connector and withdraws the SIM card out of the SIM card connector with their fingers.

Some conventional mobile devices accept and use a uSD card and either a 3FF SIM card or 4FF SIM card. Users of products that have both a 3FF SIM and uSD card connector often have difficulty in visually distinguishing which slot in the product accepts which card, because the slots are similar in size and shape. The 3FF SIM is 15 mm×12 mm and the uSD is 15 mm×11 mm. The 4FF SIM measures 12.3 mm×8.8 mm. There is always a concern that the user will incorrectly insert the SIM card into the SD card connector, or vice versa, potentially damaging the SIM card, SD card, connector, and/or mobile device.

In the past, a single connector was used to accept one and the other type of memory card by using either a combination (combo) system with separate connections and retention footprints, or a stacked system with separate slots and orientations. These combination systems and stacked systems have met with varying degrees of success, but are often cumbersome and take up a lot of space.

It is, therefore, desirable to provide an electronic connector capable of accepting a single subscriber identity module or a memory card which overcomes most, if not all, of the preceding disadvantages.

### BRIEF DESCRIPTION OF THE DRAWINGS

FIG. 1 is a top perspective view of an electronic communications device with single connectors in accordance with principles of the present invention.

FIG. 2 is a diagrammatic view of a single connector for accepting a nano-SIM 4^{th} form-factor (4FF) card or a microSD (uSD) card in accordance with principles of the present invention.

FIG. 3 is another diagrammatic view of a single connector for accepting a nano-SIM 4^{th} form-factor (4FF) card or a microSD (uSD) card in accordance with principles of the present invention.

FIG. 4 is a top perspective view of a single connectors comprising a card access tray for accepting a nano-SIM 4^{th} form-factor (4FF) card or a microSD (uSD) card in accordance with principles of the present invention.

FIG. 5 is a top perspective view of a single connectors comprising a card access tray for accepting a a microSD (uSD) card in accordance with principles of the present invention.

FIG. 6 is a top perspective view of a single connectors comprising a card access tray for accepting a nano-SIM 4^{th} form-factor (4FF) card in accordance with principles of the present invention.

FIG. 7 is a reduced side view of a footprint of a nano-SIM 4^{th} form-factor (4FF) card overlying a nano-SIM 4^{th} form-factor (4FF) card in a single connector in accordance with principles of the present invention.

FIG. 8 is a bottom perspective view of an electronic communications device with a single connector in accordance with principles of the present invention.

### DETAILED DESCRIPTION OF THE INVENTION

An improved electronic connector capable of accepting a single subscriber identity module or a memory card is provided, which is effective, economical, and easy to use. Desirably, the novel single connector provides a single cavity dual function memory card connector system that can accept a uSD card, a 3FF SIM card, or a 4FF SIM card. The user-friendly single connector is particularly suitable for the 4FF and uSD option.

The special single connector can allow the user to easily insert and place either the SIM card or uSD card into one or more single connectors in the mobile electronic device. The detection (detect) software in the mobile electronic device can safely distinguish and identify the presence, identity, and location of the card. Furthermore, the detect function software can detect which card type is in which connector. The single connector can have two sets of contacts, each set specific to one of the memory cards accepted. The single connector cannot accept more than one card at a time.

The improved single connector device can have the 6 or 8 required pins, depending on the carrier, for a SIM card (micro or nano), the 8 required pins for a uSD card, as well as detect pins and a push-pull or a push-push style ejection and removal system. Detection (detect) software can also be used without overtly impacting the x, y, or z dimensions. Either a single push-push connector designed to accept, retain, and orient either a SIM nano card or a uSD card, or a tray and connector system connector designed to accept, retain, and orient either a SIM nano card or a uSD card can be used.

Advantageously, the novel single connector can allow suppliers to stock a single connector that could be used across all mobile electronic devices, to increase sales volume and lower cost.

The special single connector can also allow regions to easily choose what service to offer. A device destined for the U.S. can require a SIM (micro or nano) card and a uSD card, while a device destined for Asia can allow dual SIM (micro or nano), with no modification to the printed circuit board design and layout.

The user-friendly single connector can enable product platforming for multiple worldwide markets for memory usage. Product platforming can be greatly improved by use of the novel single connector and printed circuit board (PCB) layout space for internal memory in a mobile communications product in the U.S. and Europe, which are SIM and uSD supported with on-board memory not placed. Product platforming can also be improved in Asia, which is dual SIM supported with on-board memory placed. Product platforming can be further improved in devices which are SIM and uSD supported with on-board memory placed. Moreover, product platforming can be improved in devices with a tablet layout, in which a single connector on a printed circuit board can be used for carrier cell version with a SIM card or WiFi only version with a uSD card. In each of these cases, the device can simply have a bill of materials change, with no change to the PCB layout. Product platforming can also be improved in music players, which can have expandable memory through multiple cards and use uSD cards.

The recently adopted 4FF SIM size can take advantage of the versatility of the novel single connector while avoiding problems caused by conventional stacked systems. The software driven multi-card usage when coupled with onboard memory further increases the versatility of the single connector hardware design.

From a device standpoint, this novel single connector cooperates with the card reader to accept cards of different standards in a single cavity. At the system level, the novel single connector has the ability to insert either a SIM card or uSD card into the same slot and have the phone or other electronic mobile device recognize it.

In the illustrated embodiment, an electronic communications device can be provided one or more single connectors for accepting different data cards. The single connector can have a first data card-receiving cavity for receiving a first data card and a second data card-receiving cavity for receiving a second data card. Desirably, the cavities have portions overlapping each other to provide a single footprint comprising an interchangeable single data card-receiving opening for receiving and accepting only one of the data cards at a time in the electronic communications device.

The following is a detailed description and explanation of the preferred embodiments of the invention and best modes for practicing the invention.

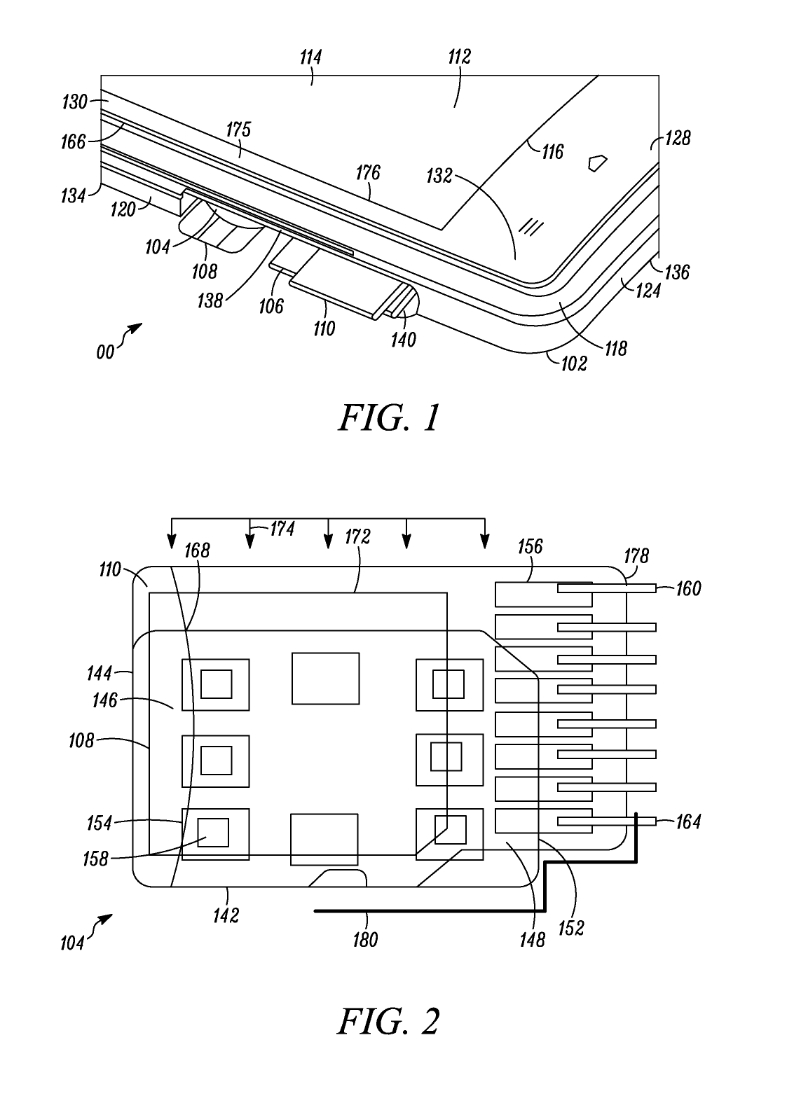

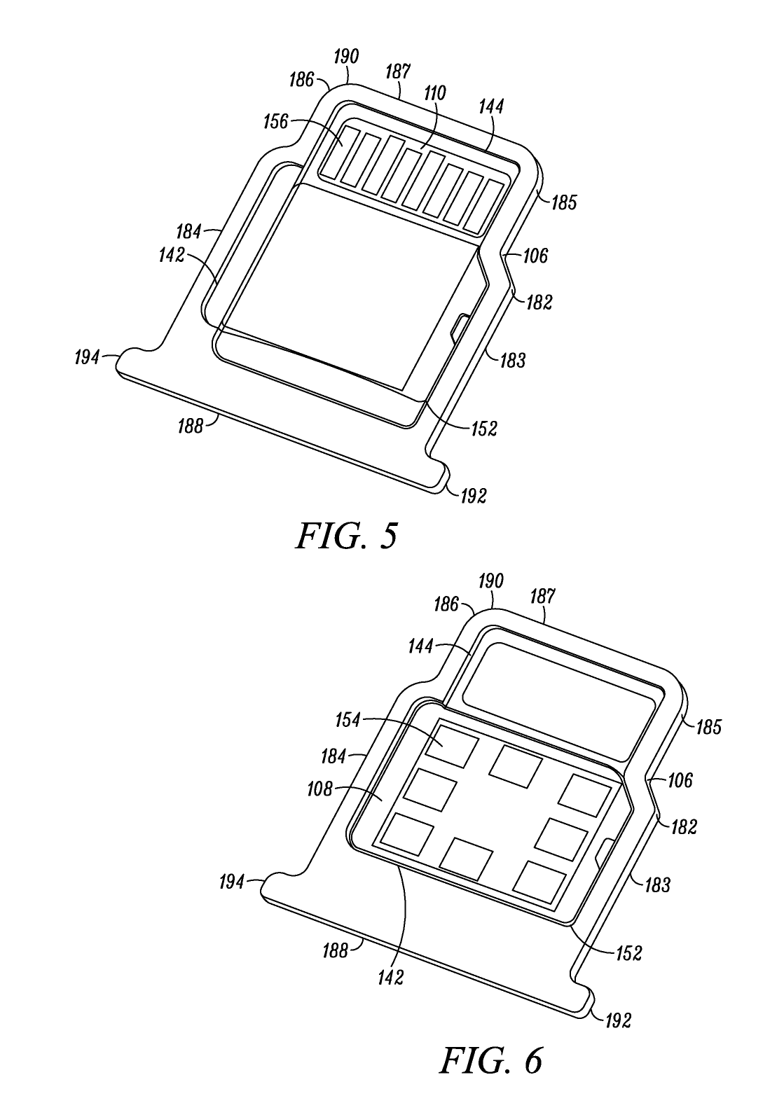

Referring to FIGS. 1, 3-5 and 8 of the drawings, a single connector assembly 100 can be provided with an electronic communications device 102 with one or more electronic single connectors 104 and/or 106. Desirably, the single connectors each receive and accept different data cards 108 or 110.

The electronic communications device can be moveable and pivotable from a landscape orientation mode (landscape mode or landscape orientation) to a portrait orientation mode (portrait mode or portrait orientation) and vice versa. The electronic communications device can comprise an electronic visual display 112 (FIG. 1) for displaying images 114. The electronic visual display can comprise a user interface (UI) 116. The electronic visual display can comprise a screen, such as an impact resistant screen, a display screen, a touchscreen, a screen with an accelerator, and combinations of any of the preceding screens.

The electronic communications device can have a modular impact-resistant housing 118 (FIGS. 1 and 8) with substantially parallel longitudinal sides 120 and 122, and substantially parallel lateral sides 124 and 126 which can extend between and be connected to the substantially parallel longitudinal sides. The housing can also have a front 128 comprising a generally rectangular frame 130 with a front surface 132 and can have a back 134 with a back surface 136. The frame can be positioned peripherally about and secure the electronic visual display. The housing can have one or more elongated slots 138 and 140 (FIG. 1) providing single connector-receiving openings for receiving the single connectors. Each elongated slot is of a size and width to substantially prevent more than one data card from being inserted at a time into the single connector that fits into that slot.

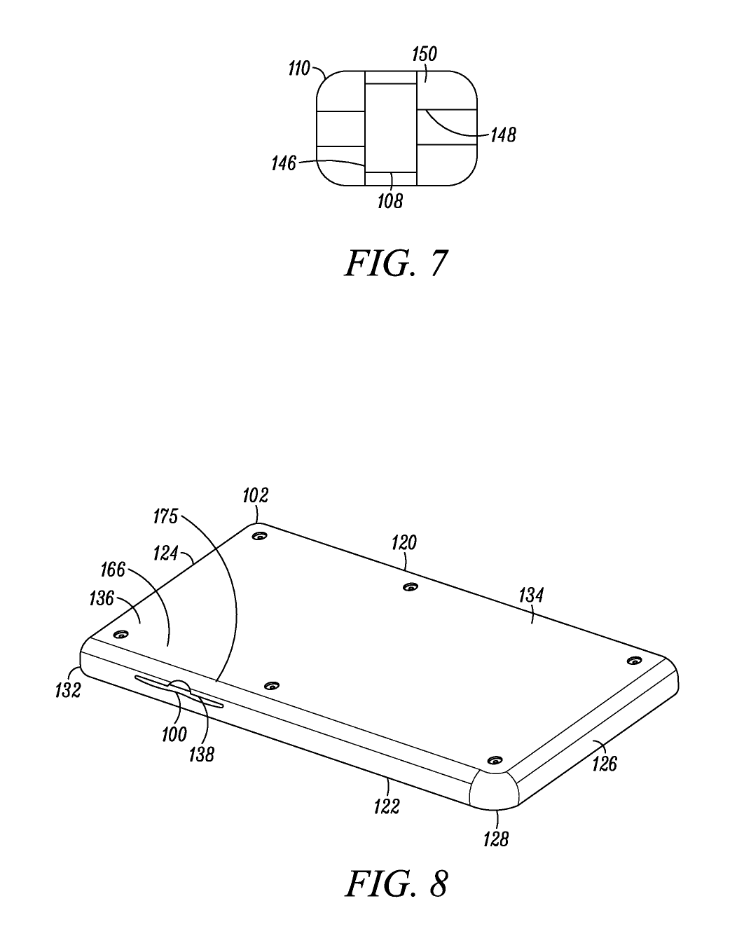

As shown in FIGS. 2-6, the single connector can have a first data card-receiving cavity 142 for receiving a first data card 108 and a second data card-receiving cavity 144 for receiving a second data card 110. The cavities for receiving the data cards can comprise: a rectangular card-receiving opening, a cutout, a cutaway, an undercut, a stepped opening, countersunk opening, hole, pad, pocket, indentation, depression, or combinations of any of the preceding. The cavities can have overlapping areas providing overlapping portions 146 and 148 (FIGS. 2-4 and 7) positioned in alignment and overlapping each other to provide a single footprint 150 (FIG. 7) comprising an interchangeable single data card-receiving opening 152 (FIGS. 2-6) which is of a size, shape and width for receiving and accepting only one of the data cards at a time in the single card connector of the electronic communications device.

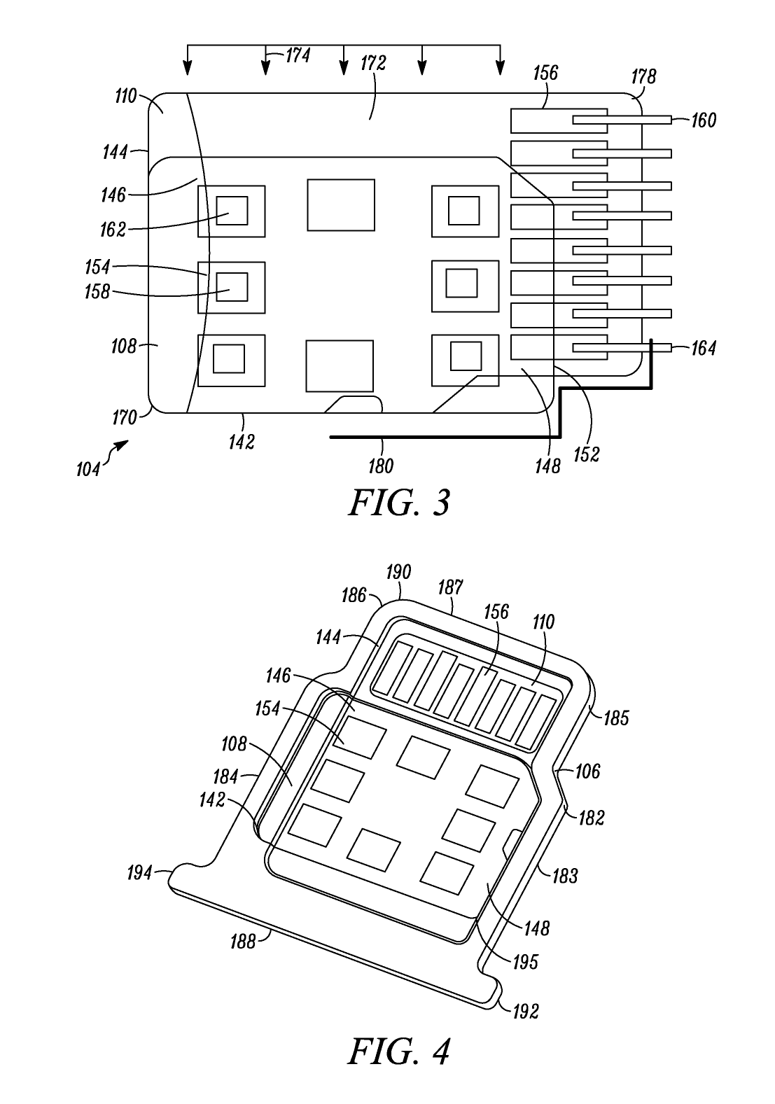

As shown in FIGS. 2-6, the first data card can have a first set of electrical data card-contacts 154 and the second data card can have a second set of electrical data card-contacts 156. The single connector can have a first set of electrical connector contacts 158 (FIG. 3) which can comprise a first set of pins for engaging and contacting first set of data card-contacts when the first data card is in the interchangeable single data card-receiving opening; and can have a second set of electrical connector contacts 160 comprising a second set of pins for engaging and contacting second set of data card-contacts when the second data card is in the interchangeable single data card-receiving opening. The pins can include at least one detect pin 162 and 164 which can cooperate with detect software 166 (FIG. 1) in the electronic communications device for detecting the presence, identity, and location of the data card in the interchangeable single data card-receiving opening.

In the illustrative embodiment, the first data card comprises a subscriber identity module (SIM) card, preferably a micro-SIM 3^{rd} form-factor (3FF) card or most preferably a nano-SIM 4^{th} form-factor (4FF) card, and the second data card comprises a secure device (SD) card, preferably a miniSD card or most preferably a microSD (uSD) card. The first set of data card-contacts of the SIM card can comprise six electronic data-card contacts or eight electronic data-card contacts, while the first set of electrical connector contacts of the single connector can comprise a set of six pins or a set of eight pins for engaging and contacting the six data card-contacts or eight data card-contacts, respectively, when the SIM card is in the interchangeable single data card-receiving opening. The second set of data card-contacts of the SD card can comprise eight electronic data card-contacts, while the second set of electrical connector contacts of the single connector can comprise a set of eight pins for engaging and contacting the eight data card-contacts when the SD card is in the interchangeable single data card-receiving opening. In some circumstances, it may be desirable to use a SIM card, SD card, or other data cards and electrical connector contacts with a different number of pins than 6 or 8, or a different pin arrangement.

The single connector 104 of FIGS. 2 and 3 can comprise a single push-push connector 168 or a single push-pull connector 170. The electronic communications device can have an elongated abutment wall 172 for abutting against and contacting the data card in the interchangeable single data card-receiving opening. A spring 174 can be provided for biasing, urging and abuttingly engaging the data card in the interchangeable single data card-receiving opening against the abutment wall. The spring can be: a coil spring, helical spring, compression spring, leaf spring, or tension spring.

The electronic communications device can comprise a portable electronic device with one or more electronic data card readers 175 and 176 (FIG. 1) for electronically reading the data cards. The electronic communications device can also have a printed circuit board (PCB) 178 (FIG. 3) which can be operatively connected to the single connector. Furthermore, the electronic communications device can have a card eject mechanism 180 for ejecting and removing the data card from the electronic communications device and/or single connector.

In FIGS. 4-6, the single connector 106 comprises an elongated card access tray 182 which can be inserted and received in a tray-receiving opening 140 (FIG. 1) of the housing of the electronic communications device. The tray-receiving opening can be: a slot, notch, fingernail notch, hole, recessed opening, cavity or combinations of any of the preceding. The tray-receiving opening is of a size, shape, and width for substantially preventing more than one data card from being inserted at a time into the card access tray. The card access tray can move and slide laterally outwardly at an open position extending outwardly from the electronic communications devices for access to the data card and subsequently move and slide laterally inwardly to a closed position located in the tray-receiving opening in an interior of the electronic communications device for substantially preventing access to the data card.

The card access tray can have substantially parallel wider elongated sides 183-184 (FIGS. 4-6), substantially parallel narrower elongated sides 185-186, and substantially parallel transverse ends providing a back end 187 and a front end 188 that can extend longitudinally across and integrally connect the sides at about right angles. The corners 190 of the tray can be rounded. The front end of the tray can have a longitudinal span and width greater than the longitudinal span and with across the sides. The front end can also have manually graspable longitudinally extending finger tips 192 and 194 which can be grasped by the user's fingers to pull and remove the card access tray tray-receiving opening from the tray-receiving opening or to push and insert the tray into the tray-receiving opening.

The card access tray can comprise a generally rectangular tray, a removable tray, a slidable tray, or combinations of the preceding trays. The tray can be molded of fabricated of plastic, aluminum or other light weight metal, or a composite material. The tray-receiving opening can include elongated transverse grooves which can provide rails or tracks for slidably receiving the card access tray. The card access trays can have detents providing track-engageable locks for interlockingly engaging the tracks and securing the tray when the tray is in the closed position.

The electronic communications device can comprise a portable electronic device, such as: a radiotelephone, cellular (cell) phone, mobile phone, smart phone, qwerty phone, flip phone, slider phone, android phone, tablet phone, camera phone, clamshell device, portable networking device, portable gaming device, mobile communications device, personal digital assistant (PDA), wireless e-mail device, a two way pager, internet communication device, android tablet, ipod, ipad, kindle, electronic reading device, incoming call notifier, answering machine, or combinations of any of the preceding.

The images displayed on the electronic display comprising a screen can comprise one or more of the following: graphics, color graphics, black graphics, moving graphics, text, numbers, alpha numeric images, characters, icons, animation, video clips, logos, photographs, decorations, designs, symbols, information, and data.

The data card(s) can comprise: a subscriber identity module card (SIM card), full-size SIM 1^{st} form factor (1FF) card, mini-SIM 2^{nd} form-factor (2FF) card, micro-SIM 3^{rd} form-factor (3FF) card, nano-SIM 4^{th} form-factor (4FF) card, secure device card (SD card), standard SD card, miniSD card, microSD (uSD) card, memory card, storage card, expanded external memory card, or combinations of any of the preceding.

Among the many advantages of the single connector capable of accepting a micro-SIM 3^{rd} form-factor (3FF) card, nano-SIM 4^{th} form-factor (4FF) card, micro secure device (uSD) card or other memory card, are:
1. Superior capability.
2. Superb performance.
3. Outstanding ability to hold a SIM card and/or SD card.
4. Allow suppliers to stock a single connector.
5. Useful to accommodate different platforms in different regions and countries.
6. Increased internal space for antennas and printed circuit boards.
7. Versatile.
8. Reliable.
9. User friendly.
10. Easy to use.
11. Durable.
12. Economical.
13. Attractive.
14. Efficient.
15. Effective.

The single connector provides unexpected surprisingly good results.

Although embodiments of the invention have been shown and described, it is to be understood that various modifications, substitutions, and rearrangements of parts, components, and/or process (method) steps, as well as other uses of the single connector and electronic communications device can be made by those skilled in the art without departing from the novel spirit and scope of this invention.

What is claimed is:

1. A single connector assembly, comprising:
an electronic communications device having at least one single connector for accepting different data cards;
said single connector having a first data card-receiving cavity for receiving a first data card and a second data card-receiving cavity for receiving a second data card; and
said cavities having portions overlapping each other to provide a single footprint comprising an interchangeable single data card-receiving opening for receiving and accepting only one of said data cards at a time in said electronic communications device.

2. A single connector assembly in accordance with claim 1 wherein said interchangeable single data card-receiving opening provides a slot for substantially preventing more than one data card from being inserted at a time into said single connector.

3. A single connector assembly in accordance with claim 1 wherein said single connector has a first set of contacts for connection to said first data card when said first data card is inserted into said first data card-receiving cavity.

4. A single connector assembly in accordance with claim 3 wherein said single connector has a second set of contacts for connection to said second data card when said second data card is inserted into said second data card-receiving cavity.

5. A single connector assembly in accordance with claim 1 wherein said single connector is selected from the group consisting of a push-push connector and push-pull connector.

6. A single connector assembly in accordance with claim 1 including a wall; and
a spring for biasing and urging said data card in said interchangeable single data card-receiving opening against said wall.

7. A single connector assembly in accordance with claim 1 wherein said single connector comprises a card access tray.

8. A single connector assembly in accordance with claim 7 wherein:
said an electronic communications device has tray-receiving opening for receiving said card access tray;
said card access tray is moveable from an open position extending outward from said electronic communications devices for access to said data card in said interchangeable single data card-receiving opening to a closed position disposed in said tray-receiving opening in an interior of said electronic communications device for substantially preventing access to said data card in said interchangeable single data card-receiving opening; and
said tray comprises a card-supporting surface for supporting at least one said data card, and said card-supporting surface is positioned in proximity to said card-receiving opening.

9. A single connector assembly in accordance with claim 1 wherein. said data card is selected from the group consisting of. a subscriber identity module card (SIM card), full-size SIM 1^{st} form factor (1FF) card, mini-SIM 2^{nd} form-factor (2FF) card, micro-SIM 3^{rd} form-factor (3FF) card, nano-SIM 4^{th} form-factor (4FF) card, secure device card (SD card), standard SD card, miniSD card, microSD (uSD) card, memory card, storage card, expanded external memory card, and combinations of any of the preceding.

10. A single connector assembly in accordance with claim 1 wherein said electronic communications device comprises a portable electronic device selected from the group consisting of. a radiotelephone, cellular (cell) phone, mobile phone, smart phone, qwerty phone, flip phone, slider phone, android phone, tablet phone, camera phone, clamshell device, portable networking device, portable gaming device, mobile communications device, personal digital assistant (PDA), wireless e-mail device, two way pager, internet communication device, android tablet, ipod, ipad, kindle, electronic reading device, electronic photo frame, digital photo frame, digital picture frame, video player, audio player, electronic calculator, electronic monitor, blackberry, tablet device, video device, computer, netbook, data sharing device, wireless device, handheld electronic communications device, global positioning system (GPS), navigation device, transmitting device, electronic receiving device, electronic planner, workout planner, electronic calendar, scheduling device, music player, MP3 player, performance monitor, golf tracker, incoming call notifier, answering machine, statistical storage device, data storage device, information storage device, cadence sensor, goal setting device, fitness tracker, exercise monitor, sports monitor, workout frequency monitor, downloadable device, computer, Bluetooth compatible device, data sharing device, and combinations of any of the preceding.

11. A single connector assembly, comprising:
an electronic communications device having at least one single connector for accepting different data cards, an electronic visual display comprising a user interface for displaying images, a chassis comprising a modular impact-resistive housing providing a frame positioned about and securing said electronic visual display, and an elongated slot providing a single connector-receiving opening in said housing for receiving said single connector;
said modular impact-resistive housing having substantially parallel longitudinal sides, substantially parallel lateral sides extending between and connected to said substantially parallel longitudinal sides, a front comprising a generally rectangular frame with a front surface and having a back with a back surface, said frame positioned peripherally about and securing said electronic visual display;
said single connector having a first data card-receiving cavity for receiving a first data card and a second data card-receiving cavity for receiving a second data card; and
said cavities having overlapping areas providing overlapping portions positioned in alignment and overlapping each other to provide a single footprint comprising an interchangeable single data card-receiving opening for receiving and accepting only one of said data cards at a time in said electronic communications device;
said first data card having a first set of electrical data card-contacts;
said second data card having a second set of electrical data card-contacts;
said single connector having a first set of electrical connector contact comprising a first set of pins for engaging and contacting said first set of data card-contacts when said first data card is in said interchangeable single data card-receiving opening;
said single connector having a second set of electrical connector contacts comprising a second set of pins for engaging and contacting second set of data card-contacts when said second data card is in said interchangeable single data card-receiving opening;
said elongated slot is of a size and shape for substantially preventing more than one data card from being inserted at a time into said single connector; and
said single connector comprises a push-push connector or a push-pull connector.

12. A single connector assembly in accordance with claim 11 including:
an abutment wall for abutting against said data card in said interchangeable single data card-receiving opening;
a spring for biasing and urging said data card in said interchangeable single data card-receiving opening against said abutment wall; and
said spring being selected from the group consisting of a coil spring, helical spring, compression spring, leaf spring, and tension spring.

13. A single connector assembly in accordance with claim 11 wherein said pins include at least one detect pin cooperating with detect software for detecting the presence, identity, and location of said data card in said interchangeable single data card-receiving opening.

14. A single connector assembly in accordance with claim 11 wherein:
said electronic visual display comprises a screen selected from the group consisting of. an impact resistant screen, a display screen, a touchscreen, a screen with an accelerator, a monitor, and combinations of any of the preceding;
said images are selected from the group consisting of. graphics, color graphics, black graphics, moving graphics, text, numbers, alpha numeric images, characters, icons, animation, video clips, logos, photographs, decorations, designs, symbols, information, data, and combinations of the preceding;
said cavities for receiving said data cards are selected from the group consisting of. a rectangular card-receiving opening, a cutout, a cutaway, an undercut, a stepped opening, countersunk opening, hole, pad, pocket, indentation, depression, and combinations of any of the preceding;
said data card is selected from the group consisting of. a subscriber identity module card (SIM card), full-size SIM 1^{st} form factor (1FF) card, mini-SIM 2^{nd} form-factor (2FF) card, micro-SIM 3^{rd} form-factor (3FF) card, nano-SIM 4^{th} form-factor (4FF) card, secure device card (SD card), standard SD card, miniSD card, microSD (uSD) card, memory card, storage card, expanded external memory card, and combinations of any of the preceding cards;
said electronic communications device comprises a portable electronic device with an electronic data card reader for electronically reading said data card;
said portable electronic device having a printed circuit board (PCB) operatively connected to said single connector and having a card eject mechanism for ejecting and removing said data card from said portable electronic device; and
said portable electronic device is selected from the group consisting of. a radiotelephone, cellular (cell) phone, mobile phone, smart phone, qwerty phone, flip phone, slider phone, android phone, tablet phone, camera phone, clamshell device, portable networking device, mobile communications device, personal digital assistant (PDA), wireless e-mail device, two way pager, internet communication device, android tablet, ipod, ipad, kindle, electronic reading device, incoming call notifier, answering machine, and combinations of any of the preceding.

15. A single connector assembly in accordance with claim 11 wherein:
said first data card comprises a subscriber identity module (SIM) card selected from the group consisting of a nano-SIM 4^{th} form-factor (4FF) card and a micro-SIM 3^{rd} form-factor (3FF) card;
said first set of data card-contacts of said SIM card comprising six or eight electronic data-card contacts;
said first set of electrical connector contacts of said single connector comprises a set of six pins for engaging and contacting said six data card-contacts or eight pins for engaging and contacting said eight data card-contacts when said SIM card is in said interchangeable single data card-receiving opening;
said second data card comprises a secure device (SD) card selected from the group consisting of a miniSD card and a microSD (uSD) card;
said second set of data card-contacts of said SD card comprising eight electronic data card-contacts; and
said second set of electrical connector contacts of said single connector comprises a set of eight pins for engaging and contacting said eight data card-contacts when said SD card is in said interchangeable single data card-receiving opening.

16. A single connector assembly, comprising:
at least one single connector comprising a card access tray for accepting different data cards;
an electronic communications device having an electronic visual display comprising a user interface for displaying images, a chassis comprising a modular impact-resistive housing providing a frame positioned about and securing said electronic visual display, and an elongated slot providing a tray-receiving opening in said housing for receiving said card access;
said modular impact-resistive housing having substantially parallel longitudinal sides, substantially parallel lateral sides extending between and connected to said substantially parallel longitudinal sides, a front comprising a generally rectangular frame with a front surface and having a back with a back surface, said frame positioned peripherally about and securing said electronic visual display;
said card access tray having a first data card-receiving cavity for receiving a first data card and at least one first card-supporting surface position about said first card-receiving cavity for supporting said first data card;
said card access tray having a second data card-receiving cavity for receiving a second data card and at least one second card-supporting surface position about said second data card-receiving cavity for supporting said second data card;
said cavities having overlapping areas providing overlapping portions positioned in alignment and overlapping each other to provide a single footprint comprising an interchangeable single data card-receiving opening for receiving and accepting only one of said data cards at a time in said electronic communications device;
said first data card having a first set of electrical data card-contacts;
said second data card having a second set of electrical data card-contacts;
said single connector having a first set of electrical connector contact comprising a first set of pins for engaging and contacting said first set of data card-contacts when said first data card is in said interchangeable single data card-receiving opening;
said single connector having a second set of electrical connector contacts comprising a second set of pins for engaging and contacting said second set of data card-contacts when said second data card is in said interchangeable single data card-receiving opening;
said elongated slot is of a size and shape for substantially preventing more than one data card from being inserted at a time into said single connector; and
said card access tray is moveable from an open position extending outward from said electronic communications devices for access to said data card in said interchangeable single data card-receiving opening to a closed position disposed in said tray-receiving opening in an interior of said electronic communications device for substantially preventing access to said data card in said interchangeable single data card-receiving opening.

17. A single connector assembly in accordance with claim 16 wherein:
said access tray is selected from the group consisting of a generally rectangular tray, a removable tray, a slidable tray, and combinations of the preceding; and
said tray-receiving opening is selected from the group consisting of. a tray-receiving slot, notch, fingernail notch, hole, recessed opening, cavity and combinations of any of the preceding.

18. A single connector assembly in accordance with claim 16 wherein said pins include at least one detect pin cooperating with detect software for detecting the presence, identity and location of said data card in said interchangeable single data card-receiving opening.

19. A single connector assembly in accordance with claim 16 wherein:
said electronic visual display comprises a screen selected from the group consisting of. an impact resistant screen, a display screen, a touchscreen, a screen with an accelerator, a monitor, and combinations of any of the preceding;
said images are selected from the group consisting of. graphics, color graphics, black graphics, moving graphics, text, numbers, alpha numeric images, characters, icons, animation, video clips, logos, photographs, decorations, designs, symbols, information, data, and combinations of the preceding;
said cavities for receiving said data cards are selected from the group consisting of. a rectangular card-receiving opening, a cutout, a cutaway, an undercut, a stepped opening, countersunk opening, hole, pad, pocket, indentation, depression, and combinations of any of the preceding;
said data card is selected from the group consisting of. a subscriber identity module card (SIM card), full-size SIM 1^{st} form factor (1FF) card, mini-SIM 2^{nd} form-factor (2FF) card, micro-SIM 3^{rd} form-factor (3FF) card, nano-SIM 4^{th} form-factor (4FF) card, secure device card (SD card), standard SD card, miniSD card, microSD (uSD) card, memory card, storage card, expanded external memory card, and combinations of any of the preceding cards;
said electronic communications device comprises a portable electronic device with an electronic data card reader for electronically reading said data card;
said portable electronic device having a printed circuit board (PCB) operatively connected to said single connector; and
said portable electronic device is selected from the group consisting of. a radiotelephone, cellular (cell) phone, mobile phone, smart phone, qwerty phone, flip phone, slider phone, android phone, tablet phone, camera phone, clamshell device, portable networking device, mobile communications device, personal digital assistant (PDA), wireless e-mail device, two way pager, internet communication device, android tablet, ipod, ipad, kindle, electronic reading device, incoming call notifier, answering machine, and combinations of any of the preceding.

20. A single connector assembly in accordance with claim 11 wherein:
said first data card comprises a subscriber identity module (SIM) card selected from the group consisting of a nano-SIM 4^{th} form-factor (4FF) card and a micro-SIM 3^{rd} form-factor (3FF) card;
said first set of data card-contacts of said SIM card comprising six or eight electronic data-card contacts;
said first set of electrical connector contacts of said card access tray comprises a set of either six pins for engaging and contacting said six data card-contacts or eight pins for engaging and contacting said eight data card-contacts when said SIM card is in said interchangeable single data card-receiving opening of said card access tray;
said second data card comprises a secure device (SD) card selected from the group consisting of a miniSD card and a microSD (uSD) card;
said second set of data card-contacts of said SD card comprising eight electronic data card-contacts; and
said second set of electrical connector contacts of said card access tray comprises a set of eight pins for engaging and contacting said eight data card-contacts when said SD card is in said interchangeable single data card-receiving opening of said card access tray.
